(19) United States
(12) Patent Application Publication
(10) Pub. No.: US 2017/0026264 A1
(43) Pub. Date: Jan. 26, 2017

(54) TRANSMISSION DEVICE AND TRAFFIC AMOUNT MEASUREMENT METHOD

(71) Applicant: FUJITSU LIMITED, Kawasaki-shi (JP)

(72) Inventors: Takashi Ishikawa, Fukuoka (JP); Shinichi Fujiyoshi, Fukuoka (JP); YOSHINARI SUGIMOTO, Fukuoka (JP); Tatsuyuki Muramatsu, Chigasaki (JP); Kentarou OKU, Kawasaki (JP)

(73) Assignee: FUJITSU LIMITED, Kawasaki-shi (JP)

(21) Appl. No.: 15/167,218

(22) Filed: May 27, 2016

(30) Foreign Application Priority Data
Jul. 21, 2015 (JP) 2015-143927

(51) Int. Cl. H04L 12/26

(52) U.S. Cl. CPC H04L 43/0882; H04L 43/062

(57) ABSTRACT

A transmission device includes: one or more processors; and a memory configured to store a program which is executed by the one or more processors, wherein the one or more processors is configured to: measure a communication traffic amount on a line; calculate a degree of change in the communication traffic amount; compare the degree of change in the communication traffic amount with a threshold; and measure, in accordance with a comparison result, the communication traffic amount on the line in accordance with one of a first measurement cycle and a second measurement cycle that is shorter than the first measurement cycle.

### CROSS-REFERENCE TO RELATED APPLICATION

This application is based upon and claims the benefit of priority of the prior Japanese Patent Application No. 2015-143927, filed on Jul. 21, 2015, the entire contents of which are incorporated herein by reference.

### FIELD

The embodiments discussed herein are related to a transmission device and a traffic amount measurement method.

### BACKGROUND

As the bandwidth of communication networks has become wider and components have been accommodated therein more closely, relay devices have been enabled to perform simultaneous communication with a number of terminal devices.

International Publication Pamphlet No. WO2012/147909 discusses related technology.

### SUMMARY

According to an aspect of the embodiments, a transmission device includes: one or more processors; and a memory configured to store a program which is executed by the one or more processors, wherein the one or more processors is configured to: measure a communication traffic amount on a line; calculate a degree of change in the communication traffic amount; compare the degree of change in the communication traffic amount with a threshold; and measure, in accordance with a comparison result, the communication traffic amount on the line in accordance with one of a first measurement cycle and a second measurement cycle that is shorter than the first measurement cycle.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example transmission system;

FIG. 2 illustrates an example functional configuration of a monitoring unit;

FIGS. 3A and 3B each illustrate an example relationship between a communication traffic amount and time;

FIG. 4 illustrates example processing operations of a CPU;

FIG. 5 illustrates an example functional configuration of a monitoring unit;

FIGS. 6A and 6B each illustrate an example relationship between a communication traffic amount and time; and

FIG. 7 illustrates example processing operations of a CPU.

### DESCRIPTION OF EMBODIMENTS

A micro-bursting event in a communication network causes a packet loss, line quality deterioration, and the like because a large volume of communication is suddenly performed in a short time. Since micro-bursting occurs suddenly, it is difficult to identify micro-bursting and analyze the causes thereof. Accordingly, a method for detecting micro-bursting may be provided.

For example, when an amount of communication traffic measured on a line exceeds a threshold for an abnormal traffic amount, marking may be performed, and the marking may be used to recognize a traffic amount abnormality, for example, a burst abnormality.

For example, although the marking is performed when the communication traffic amount exceeds the threshold for an abnormal traffic amount, the state of the communication traffic amount before the measured traffic amount exceeds the threshold for an abnormal traffic amount may not be recognized. Since the state of the communication traffic amount before the measured traffic amount exceeds the threshold for an abnormal traffic amount, for example, the state of the communication traffic amount before the abnormality occurrence is not recognized, a causal event before the occurrence of the abnormal traffic amount, for example, a causal event before the micro-bursting occurrence may not be analyzed.

The embodiments described below may be combined appropriately without causing inconsistency.

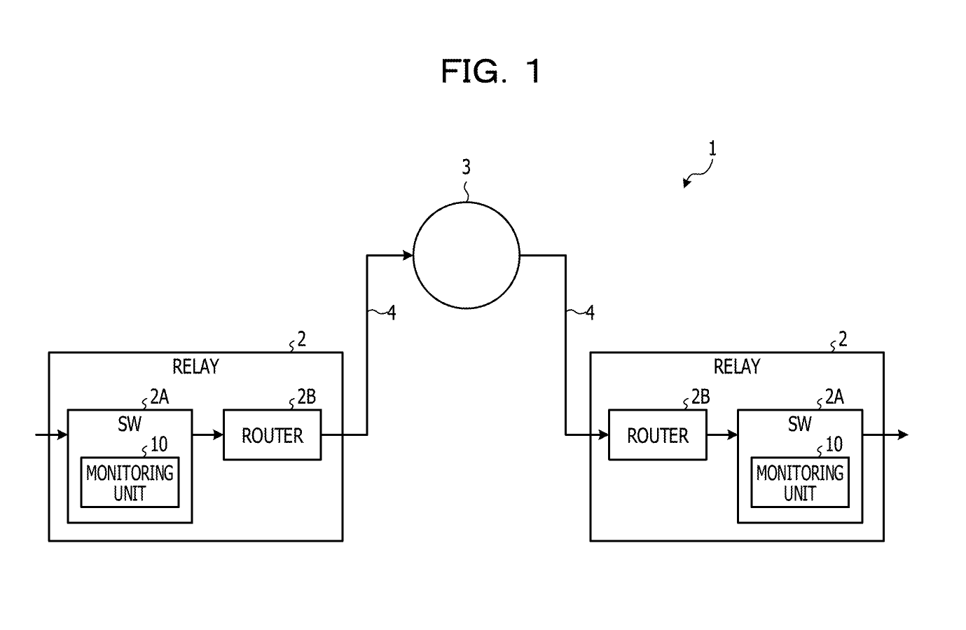

FIG. 1 illustrates an example of a transmission system 1. The transmission system 1 illustrated in FIG. 1 includes a plurality of relays 2 and a network 3. Each relay 2 is connected to the network 3 through a corresponding one of lines 4 and is, for example, a packet relay device that relays a packet through the line 4. The relay 2 includes a switch (SW) 2A and a router 2B. The SW 2A is a switch for, for example, Layer 2/Layer 3 (L2/L3). The SW 2A includes a monitoring unit 10 that monitors the amount of traffic of packets flowing through the line 4, for example, a communication traffic amount. The router 2B is connected to the line 4 and is a routing switch that transfers a packet based on destination information in the packet.

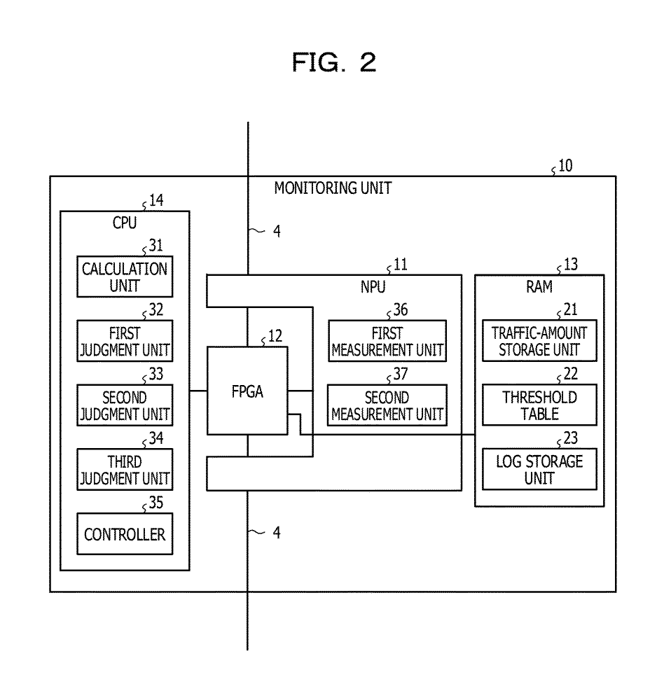

FIG. 2 illustrates an example functional configuration of a monitoring unit. The monitoring unit 10 illustrated in FIG. 2 includes a network processor unit (NPU) 11, a field programmable gate array (FPGA) 12, a random access memory (RAM) 13, and a central processor unit (CPU) 14. The NPU 11 corresponds to a communication processor connected to the line 4 and measures a communication traffic amount in the line 4. The NPU 11 measures the communication traffic amount (bps) in the line 4 in accordance with a predetermined measurement cycle, for example, in accordance with a one-millisecond (1-ms) cycle.

The FPGA 12, for example, connects the CPU 14 and the RAM 13, the CPU 14 and the NPU 11, and the NPU 11 and the RAM 13. The FPGA 12 is a large scale integrated circuit (LSI) that executes various processes. The RAM 13 is a memory unit such as a double-data-rate 3 synchronous dynamic random access memory (DDR3 SDRAM) that stores various pieces of information. The CPU 14 performs overall control on the monitoring unit 10.

The RAM 13 stores various programs such as a traffic-amount measurement program. The RAM 13 includes a traffic-amount storage unit 21, a threshold table 22, and a log storage unit 23. The traffic-amount storage unit 21 is an area for serially storing communication traffic amounts measured by the NPU 11. The threshold table 22 is an area for storing, for example, a first threshold, a second threshold, and a third threshold.

The log storage unit 23 is an area for storing logs that are each a communication history including results of communication traffic amount measurement performed in virtual local area network (VLAN) units by the NPU 11, a time stamp, a VLAN identifier (ID), a flow ID, and the like. The CPU 14 reads out the traffic-amount measurement program stored in the RAM 13 and implements the functions of a calculation unit 31, a first judgment unit 32, a second judgment unit 33, a third judgment unit 34, and a controller 35 based on the read out traffic-amount measurement program. The NPU 11 implements the functions of a first measurement unit 36 and a second measurement unit 37 based on the traffic-amount measurement program.

The first measurement unit 36 serially measures communication traffic amounts in the line 4, for example, in accordance with the 1-ms measurement cycle and serially stores measurement results in the traffic-amount storage unit 21. The calculation unit 31 calculates the degree of change in the communication traffic amounts stored in the traffic-amount storage unit 21. The degree of change in the communication traffic amounts represents an amount of change in communication traffic amounts corresponding to 10 ms that are to be monitored among the communication traffic amounts stored in the traffic-amount storage unit 21. The calculation unit 31 serially calculates the amounts of change in 10-ms communication traffic amounts, that is, every 10 ms, for example, in such a manner as to calculate an amount of change in traffic amounts in a period from 1 ms to 10 ms, an amount of change in communication traffic amounts in a period from 11 ms to 20 ms, and an amount of change in communication traffic amounts in a period from 21 ms to 30 ms.

The second measurement unit 37 enables setting of two types of log acquisition modes such as a normal mode and a detail mode. During the normal mode, the second measurement unit 37 collects logs of, for example, a communication traffic amount, a time stamp, a VLAN ID, a flow ID, and the like that are measured in accordance with a one-second (1-s) measurement cycle in VLAN units and stores the collected logs in the log storage unit 23. The time stamp represents the date and time of measurement of the communication traffic amount of a packet, and the VLAN ID and the flow ID are IDs for respectively identifying a user of the packet and the packet.

During the detail mode, the second measurement unit 37 collects logs of, for example, a communication traffic amount, a time stamp, a VLAN ID, a flow ID, and the like that are measured in accordance with a 1-ms measurement cycle in VLAN units and stores the collected logs in the log storage unit 23. For example, the number of logs collected in the detail mode is 1000 times the number of logs collected in the normal mode.

The controller 35 sets the normal mode as the initial setting in the second measurement unit 37. The first judgment unit 32 is, for example, a judgment unit that judges whether the degree of change in the communication traffic amounts exceeds the first threshold. The first threshold represents the degree of change in the communication traffic amounts for judging whether to set the detail mode in the second measurement unit 37.

If the degree of change in the communication traffic amounts exceeds the first threshold, the controller 35 sets the detail mode in the second measurement unit 37. If the degree of change in the communication traffic amounts exceeds the first threshold, the controller 35 increments a count value by one. If the degree of change in the communication traffic amounts does not exceed the first threshold, the controller 35 sets the normal mode in the second measurement unit 37. If the degree of change in the communication traffic amounts does not exceed the first threshold, the controller 35 resets the count value.

The second judgment unit 33 judges whether the communication traffic amounts exceed the second threshold. The second threshold is an upper limit value of the communication traffic amounts and represents a communication traffic amount from which packet loss occurrence is assumable on the receiving side. If the communication traffic amounts do not exceed the second threshold, the third judgment unit 34 judges whether the count value exceeds the third threshold. The third threshold represents the number of times the degree of change in the communication traffic amounts is judged to exceed the first threshold (a count value). From the number of times, a drastic increase of the communication traffic amounts before the communication traffic amounts exceed the second threshold is predictable. If the third judgment unit 34 judges that the count value exceeds the third threshold, the controller 35 sets the detail mode in the second measurement unit 37. If the third judgment unit 34 judges that the count value does not exceed the third threshold, the controller 35 sets the normal mode in the second measurement unit 37.

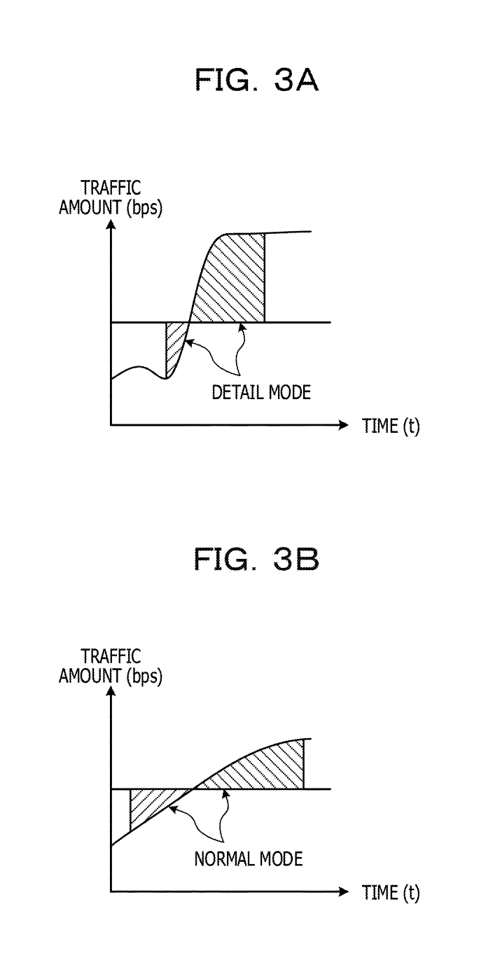

FIGS. 3A and 3B each illustrate an example relationship between a communication traffic amount and time. FIG. 3A illustrates a communication traffic amount related to mode switching performed when the degree of change increases drastically. In FIG. 3A, during the normal mode, if communication traffic amounts do not exceed the second threshold, but if the degree of change in the communication traffic amounts exceeds the first threshold, the detail mode is set in the second measurement unit 37. FIG. 3B illustrates a communication traffic amount related to mode switching performed when the degree of change increases gradually. In FIG. 3B, during the normal mode, if communication traffic amounts exceed the second threshold, but if the degree of change in the communication traffic amounts does not exceed the first threshold, the second measurement unit 37 is set in the normal mode.

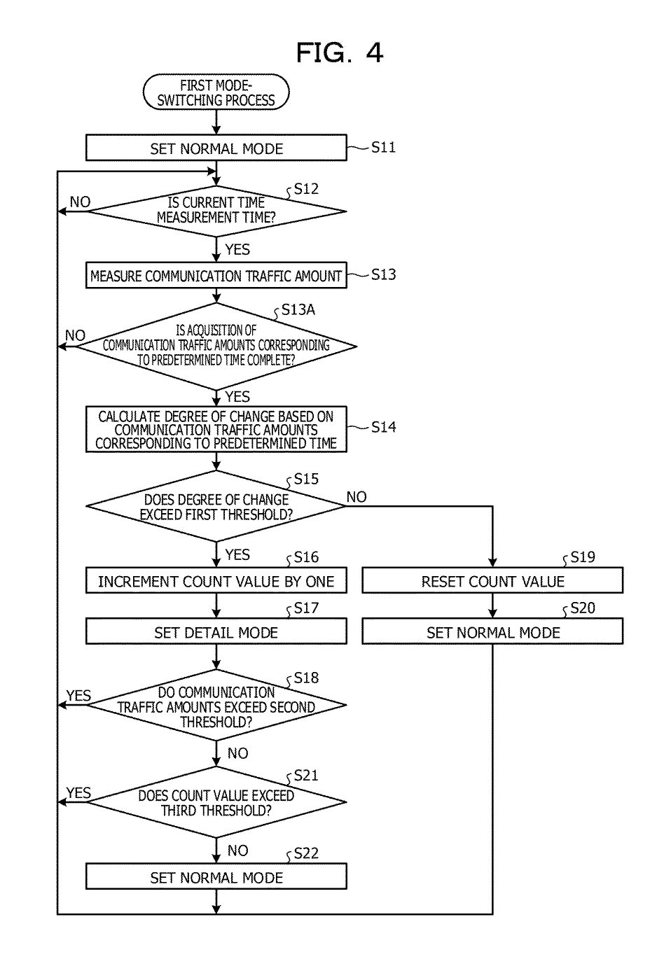

FIG. 4 illustrates example processing operations of a CPU. FIG. 4 illustrates processing operations related to a first mode-switching process performed by the CPU 14 in the monitoring unit 10. The first mode-switching process is a process in which the log acquisition mode is switched and set in the second measurement unit 37 based on the degree of change in communication traffic amounts.

In FIG. 4, the controller 35 in the CPU 14 sets the normal mode as the initial setting in the second measurement unit 37 (operation S11). The controller 35 judges whether the current time is a measurement time for the first measurement unit 36 (operation S12). The measurement cycle of the measurement time for the first measurement unit 36 may be set to 1 ms. If the current time is the measurement time (“affirmative” in operation S12), the first measurement unit 36 measures a communication traffic amount (operation S13). The first measurement unit 36 stores the measured communication traffic amount in the traffic-amount storage unit 21.

The calculation unit 31 in the CPU 14 judges whether the first measurement unit 36 completes acquisition of the communication traffic amounts corresponding to a predetermined period of time (operation S13A). The communication traffic amounts corresponding to a predetermined period of time are equivalent to, for example, communication traffic amounts corresponding to 10 ms and thus ten units of a communication traffic amount. If the acquisition of the communication traffic amounts corresponding to the predetermined period of time is complete (“affirmative” in operation S13A), the calculation unit 31 calculates the degree of change in the communication traffic amounts based on the monitored communication traffic amounts corresponding to the predetermined period of time stored in the traffic-amount storage unit 21 (operation S14). The first judgment unit 32 in the CPU 14 judges whether the degree of change in the communication traffic amounts exceeds the first threshold (operation S15). If the degree of change in the monitored communication traffic amounts exceeds the first threshold (“affirmative” in operation S15), the controller 35 judges that the possibility of micro-bursting occurrence is high and increments the count value by one (operation S16). After incrementing the count value by one, the controller 35 sets the detail mode in the second measurement unit 37 (operation S17). Since the current set mode is the detail mode, the second measurement unit 37 consequently collects the logs of communication traffic amounts in accordance with the 1-ms cycle.

After the detail mode is set, the second judgment unit 33 in the CPU 14 judges whether the monitored communication traffic amounts exceed the second threshold (operation S18). If the monitored communication traffic amounts exceed the second threshold (“affirmative” in operation S18), the process proceeds to operation S12 to cause the controller 35 to judge whether the current time is the measurement time.

If the degree of change in the monitored communication traffic amounts does not exceed the first threshold (“negative” in operation S15), the controller 35 judges that the possibility of micro-bursting occurrence is low and resets the count value (operation S19). After resetting the count value, the controller 35 sets the normal mode in the second measurement unit 37 (operation S20). The process proceeds to operation S12 to cause the controller 35 to judge whether the current time is the measurement time. Since the current set mode is the normal mode, the second measurement unit 37 consequently collects the logs of communication traffic amounts in accordance with the 1-s cycle.

If the monitored communication traffic amounts do not exceed the second threshold (“negative” in operation S18), the third judgment unit 34 in the CPU 14 judges whether the count value exceeds the third threshold (operation S21). If the count value exceeds the third threshold (“affirmative” in operation S21), the process proceeds to operation S12 to cause the controller 35 to judge whether the current time is the measurement time. Since the current set mode is the detail mode, the second measurement unit 37 consequently collects the logs of communication traffic amounts in accordance with the 1-ms cycle.

If the count value does not exceed the third threshold (“negative” in operation S21), the controller 35 sets the normal mode in the second measurement unit 37 (operation S22). The process proceeds to operation S12 to cause the controller 35 to judge whether the current time is the measurement time. Since the current set mode is the normal mode, the second measurement unit 37 consequently collects the logs of communication traffic amounts in accordance with the 1-s cycle.

If the degree of change in the communication traffic amounts exceeds the first threshold, the CPU 14 that executes the first mode-switching process sets the detail mode in the second measurement unit 37. Since the degree of change in the communication traffic amounts is high, the CPU 14 consequently judges that the possibility of micro-bursting occurrence is high and predicts micro-bursting occurrence. The second measurement unit 37 collects the logs in detail in the detail mode. The CPU 14 recognizes in detail the logs of communication traffic amounts in VLAN units based on the logs collected in the detail mode and analyzes causal events occurring, for example, before and after the micro-bursting.

If the degree of change in the communication traffic amounts does not exceed the first threshold, the CPU 14 sets the normal mode in the second measurement unit 37. Since the degree of change in the communication traffic amounts is low, the CPU 14 consequently judges that the possibility of micro-bursting occurrence is low. The second measurement unit 37 collects the logs in the normal mode. The CPU 14 may roughly recognize the logs of communication traffic amounts in VLAN units based on the logs collected in the normal mode. Since the number of logs collected in the normal mode is reduced, the CPU 14 may save a memory resource of the log storage unit 23.

Further, if the degree of change in the communication traffic amounts does not exceed the first threshold, and if the communication traffic amounts exceed the second threshold, the CPU 14 sets the normal mode in the second measurement unit 37. Even though the communication traffic amounts exceed the second threshold, the CPU 14 consequently collects the logs in the normal mode. Accordingly, this may avoid wasting a memory resource of the log storage unit 23, the wasting being caused by the detail mode set when an increase of the communication traffic amount is not caused by micro-bursting.

If the degree of change in the communication traffic amounts exceeds the first threshold, and if the communication traffic amounts exceed the second threshold, the CPU 14 sets the detail mode in the second measurement unit 37. The CPU 14 consequently judges that the possibility of micro-bursting occurrence is high. The second measurement unit 37 collects the logs in detail in the detail mode. The CPU 14 recognizes in detail the logs of communication traffic amounts in VLAN units based on the logs collected in the detail mode and may analyze causal events occurring, for example, before and after the micro-bursting.

If the communication traffic amounts do not exceed the second threshold, but if the count value exceeds the third threshold, the CPU 14 sets the detail mode in the second measurement unit 37. Even though the communication traffic amounts do not exceed the second threshold, the CPU 14 consequently judges that the possibility of micro-bursting occurrence is high. The second measurement unit 37 collects the logs in detail in the detail mode. The CPU 14 recognizes in detail the logs of communication traffic amounts in VLAN units based on the logs collected in the detail mode and analyzes causal events occurring, for example, before and after the micro-bursting.

If the communication traffic amounts do not exceed the second threshold, and if the count value does not exceed the third threshold, the CPU 14 sets the normal mode in the second measurement unit 37. The CPU 14 consequently judges that the possibility of micro-bursting occurrence is low. The second measurement unit 37 collects the logs in the normal mode. Since the number of logs collected in the normal mode is reduced, the CPU 14 may save the memory resource of the log storage unit 23.

If the degree of change in the communication traffic amounts exceeds the first threshold, and if the count value exceeds the third threshold, the CPU 14 sets the detail mode in the second measurement unit 37. Accordingly, the logs of events occurring before and after the micro-bursting occurrence are collected in detail, and the collected logs are stored in the log storage unit 23. The CPU 14 consequently analyzes causal events occurring, for example, before and after the micro-bursting occurrence, in VLAN units based on the logs of events before and the after the micro-bursting occurrence.

The CPU 14 calculates an amount of change in communication traffic amounts corresponding to the predetermined period of time measured by the first measurement unit 36 as the degree of change in the communication traffic amounts. Based on the degree of change in the communication traffic amounts, the CPU 14 consequently recognizes changes in groups of the communication traffic amounts corresponding to the predetermined period of time.

The CPU 14 sets, as the count value, the number of times the degree of change in the communication traffic amounts exceeds the first threshold. If the count value exceeds the third threshold, the CPU 14 sets the detail mode in the second measurement unit 37. The CPU 14 consequently predicts micro-bursting occurrence and sets the detail mode before the micro-bursting occurrence.

The changing direction of the degree of change in the communication traffic amounts may be an increasing direction. For example, if the degree of change exceeds the first threshold, the detail mode is set. For example, the changing direction of the degree of change in the communication traffic amounts may also be a decreasing direction. If the degree of change exceeds the first threshold, the detail mode may be set.

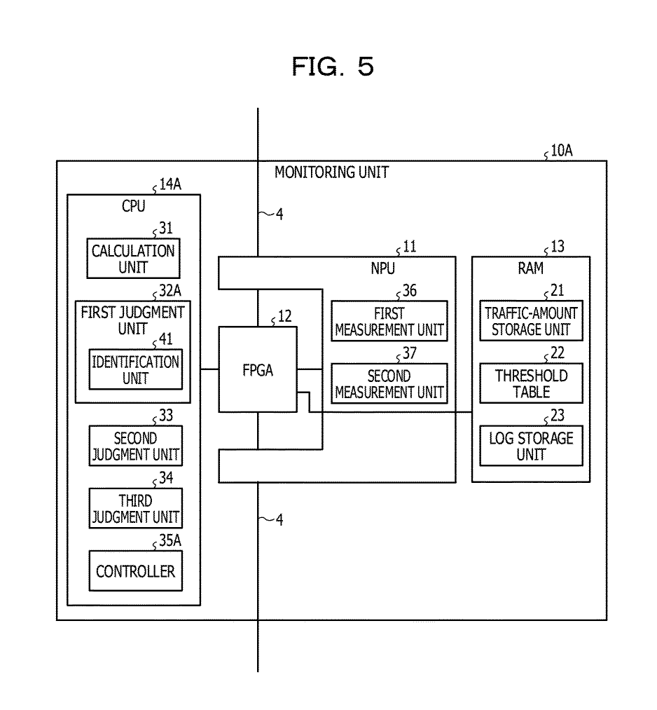

FIG. 5 illustrates an example functional configuration of a monitoring unit. Components that are substantially the same as or similar to those in the transmission system 1 illustrated in FIG. 2 are denoted by the same reference numerals, and explanation of the same components and operations may be omitted.

The difference between a monitoring unit 10A illustrated in FIG. 5 and the monitoring unit 10 illustrated in FIG. 2 is as follows. Specifically, a first judgment unit 32A identifies whether the changing direction of the degree of change in communication traffic amounts is the increasing direction or the decreasing direction. If the degree of change, in the communication traffic amount, as a matter of course in the increasing direction or in the decreasing direction exceeds the first threshold, the detail mode is set.

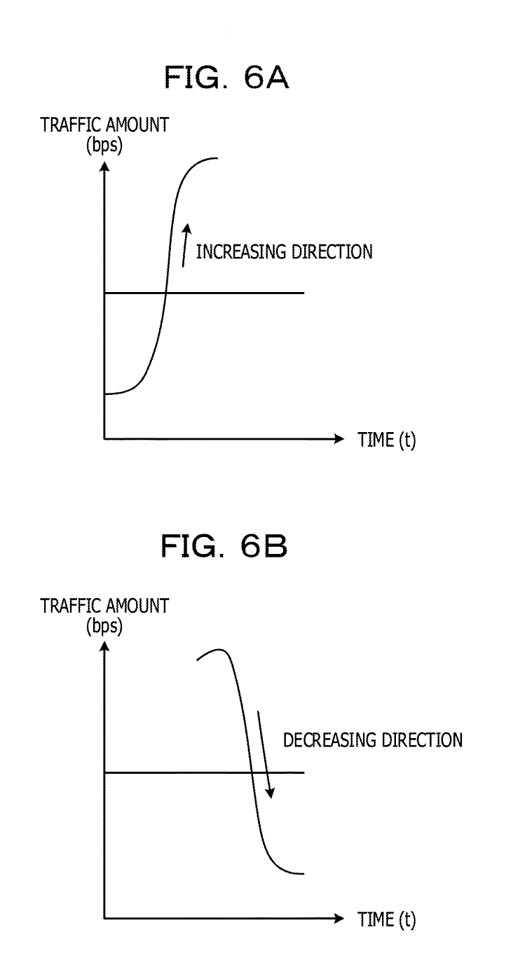

The first judgment unit 32A includes an identification unit 41 that identifies whether the changing direction of the degree of change in the communication traffic amounts is the increasing direction or the decreasing direction. FIGS. 6A and 6B each illustrate an example relationship between a communication traffic amount and time. FIG. 6A illustrates a communication traffic amount related to the degree of change in the increasing direction. If the identification unit 41 identifies the changing direction of the degree of change in the communication traffic amounts as the increasing direction as illustrated in FIG. 6A, the first judgment unit 32A judges whether the degree of change in the increasing direction exceeds the first threshold. If the degree of change in the increasing direction exceeds the first threshold, a controller 35A sets the detail mode in the second measurement unit 37. If the degree of change in the increasing direction does not exceed the first threshold, the controller 35A sets the normal mode in the second measurement unit 37.

FIG. 6B illustrates a communication traffic amount related to the degree of change in the decreasing direction. If the identification unit 41 identifies the changing direction of the degree of change in the communication traffic amounts as the decreasing direction as illustrated in FIG. 6B, the first judgment unit 32A judges whether the degree of change exceeds the first threshold. If the degree of change in the decreasing direction exceeds the first threshold, the controller 35A sets the detail mode in the second measurement unit 37. If the degree of change in the decreasing direction does not exceed the first threshold, the controller 35A sets the normal mode in the second measurement unit 37.

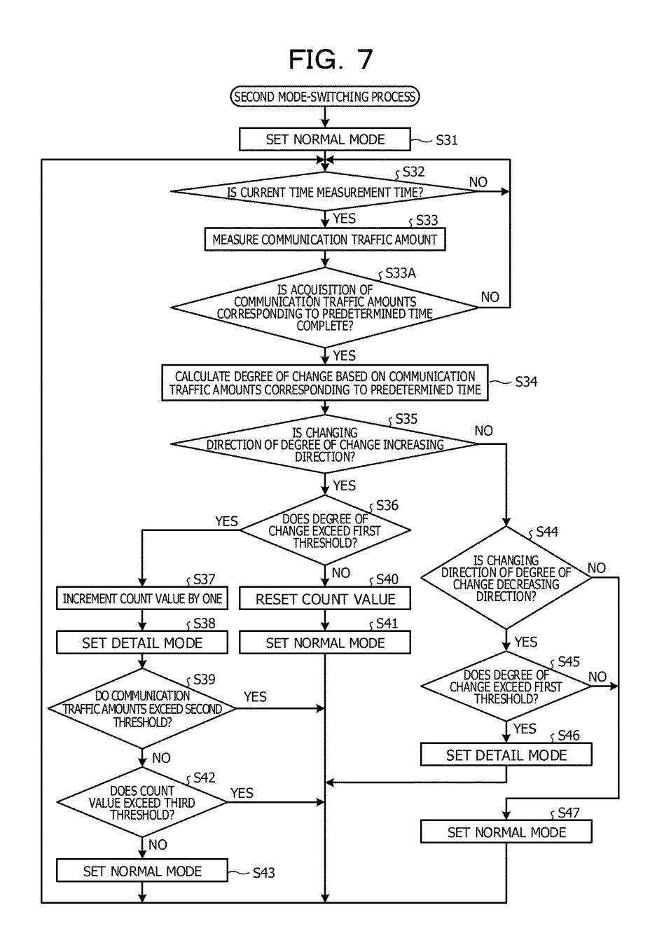

FIG. 7 illustrates example processing operations of a CPU. FIG. 7 illustrates processing operations of a CPU 14A in the monitoring unit 10A according to a second mode-switching process. The second mode-switching process is a process in which the log acquisition mode is switched and set in the second measurement unit 37 based on whether the changing direction of the degree of change in the communication traffic amounts is the increasing direction or the decreasing direction.

In FIG. 7, the controller 35A in the CPU 14A sets the normal mode as the initial setting in the second measurement unit 37 (operation S31). The controller 35A judges whether the current time is a measurement time for the first measurement unit 36 (operation S32). The measurement cycle of the measurement time for the first measurement unit 36 may be set to 1 ms. If the current time is the measurement time (“affirmative” in operation S32), the first measurement unit 36 measures a communication traffic amount (operation S33). The first measurement unit 36 stores the measured communication traffic amount in the traffic-amount storage unit 21.

The calculation unit 31 in the CPU 14A judges whether the first measurement unit 36 completes acquisition of the communication traffic amounts corresponding to the predetermined period of time (operation S33A). The communication traffic amounts corresponding to a predetermined period of time are equivalent to, for example, communication traffic amounts corresponding to 10 ms and thus ten units of a communication traffic amount. If the acquisition of the communication traffic amounts corresponding to the predetermined period of time is complete (“affirmative” in operation S33A), the calculation unit 31 calculates the degree of change in the communication traffic amounts based on the monitored communication traffic amounts corresponding to the predetermined period of time stored in the traffic-amount storage unit 21 (operation S34). The first judgment unit 32A in the CPU 14A judges whether the changing direction of the degree of change in the monitored communication traffic amounts is the increasing direction by using the identification unit 41 (operation S35).

If the changing direction of the degree of change in the monitored communication traffic amounts is the increasing direction (“affirmative” in operation S35), the first judgment unit 32A judges whether the degree of change, in the monitored communication traffic amounts, in the increasing direction exceeds the first threshold (operation S36). If the degree of change in the increasing direction exceeds the first threshold (“affirmative” in operation S36), the controller 35A judges that the possibility of micro-bursting occurrence is high and increments the count value by one (operation S37). After incrementing the count value by one, the controller 35A sets the detail mode in the second measurement unit 37 (operation S38). Since the current set mode is the detail mode, the second measurement unit 37 consequently collects the logs of communication traffic amounts in accordance with the 1-ms cycle.

After the detail mode is set, the second judgment unit 33 in the CPU 14A judges whether the monitored communication traffic amounts exceed the second threshold (operation S39). If the monitored communication traffic amounts exceed the second threshold (“affirmative” in operation S39), the process proceeds to operation S32 to cause the controller 35A to judge whether the current time is the measurement time.

If the degree of change in the increasing direction does not exceed the first threshold (“negative” in operation S36), the controller 35A judges that the possibility of micro-bursting occurrence is low and resets the count value (operation S40). After resetting the count value, the controller 35A sets the normal mode in the second measurement unit 37 (operation S41). The process proceeds to operation S32 to cause the controller 35A to judge whether the current time is the measurement time. Since the current set mode is the normal mode, the second measurement unit 37 consequently collects the logs of communication traffic amounts in accordance with the 1-s cycle.

If the monitored communication traffic amounts do not exceed the second threshold (“negative” in operation S39), the third judgment unit 34 in the CPU 14A judges whether the count value exceeds the third threshold (operation S42). If the count value exceeds the third threshold (“affirmative” in operation S42), the process proceeds to operation S32 to cause the controller 35A to judge whether the current time is the measurement time. Since the current set mode is the detail mode, the second measurement unit 37 consequently collects the logs of communication traffic amounts in accordance with the 1-ms cycle.

If the count value does not exceed the third threshold (“negative” in operation S42), the controller 35A sets the normal mode in the second measurement unit 37 (operation S43). The process proceeds to operation S32 to cause the controller 35A to judge whether the current time is the measurement time. Since the current set mode is the normal mode, the second measurement unit 37 consequently collects the logs of communication traffic amounts in accordance with the 1-s cycle.

If the changing direction of the degree of change in the monitored communication traffic amounts is not the increasing direction (“negative” in operation S35), the first judgment unit 32A judges whether the changing direction of the degree of change in the communication traffic amounts is the decreasing direction by using the identification unit 41 (operation S44). If the changing direction of the degree of change in the communication traffic amounts is the decreasing direction (“affirmative” in operation S44), the first judgment unit 32A judges whether the degree of change, in the monitored communication traffic amount, in the decreasing direction exceeds the first threshold (operation S45).

If the degree of change, in the communication traffic amount, in the decreasing direction exceeds the first threshold (“affirmative” in operation S45), the controller 35A sets the detail mode in the second measurement unit 37 (operation S46). The process proceeds to operation S32 to cause the controller 35A to judge whether the current time is the measurement time. Since the current set mode is the detail mode, the second measurement unit 37 consequently collects the logs of communication traffic amounts in the decreasing direction in accordance with the 1-ms cycle.

If the degree of change, in the communication traffic amount, in the decreasing direction does not exceed the first threshold (“negative” in operation S45), the controller 35A sets the normal mode in the second measurement unit 37 (operation S47). The process proceeds to operation S32 to cause the controller 35A to judge whether the current time is the measurement time. Since the current set mode is the normal mode, the second measurement unit 37 consequently collects the logs of communication traffic amounts in accordance with the 1-s cycle.

If the changing direction of the degree of change in the monitored communication traffic amounts is not the decreasing direction (“negative” in operation S44), the first judgment unit 32A sets the normal mode in the second measurement unit 37. Accordingly, the process proceeds to operation S47. Since the current set mode is the normal mode, the second measurement unit 37 consequently collects the logs of communication traffic amounts in accordance with the 1-s cycle.

If the degree of change, in the communication traffic amount, in the increasing direction exceeds the first threshold, the CPU 14A that executes the second mode-switching process sets the detail mode in the second measurement unit 37. Since the degree of change, in the communication traffic amount, in the increasing direction is high, the CPU 14A consequently judges that the possibility of micro-bursting occurrence is high and predicts micro-bursting occurrence. The second measurement unit 37 collects the logs in detail in the detail mode. The CPU 14A recognizes in detail the logs of communication traffic amounts in the increasing direction in VLAN units based on the logs collected in the detail mode and analyzes causal events occurring, for example, before and after the micro-bursting.

If the degree of change, in the communication traffic amount, in the decreasing direction exceeds the first threshold, the CPU 14A sets the detail mode in the second measurement unit 37. Since the degree of change, in the communication traffic amount, in the decreasing direction is high, the CPU 14A consequently judges that the possibility of recovery after the micro-bursting occurrence is high. The second measurement unit 37 collects the logs in detail in the detail mode. The CPU 14A recognizes in detail the logs of the communication traffic amounts in the decreasing direction in VLAN units based on the logs collected in the detail mode and analyzes, for example, causal events of the recovery from the micro-bursting.

If the degree of change, in the communication traffic amount, in the increasing direction does not exceed the first threshold, the CPU 14A sets the normal mode in the second measurement unit 37. Since the degree of change, in the communication traffic amount, in the increasing direction is low, the CPU 14A consequently judges that the possibility of micro-bursting occurrence is low. The second measurement unit 37 collects the logs in the normal mode. The CPU 14A roughly recognizes the logs of communication traffic amounts in the increasing direction in VLAN units based on the logs collected in the normal mode. Since the number of logs collected in the normal mode is reduced, the CPU 14A may save the memory resource of the log storage unit 23.

If the degree of change, in the communication traffic amount, in the increasing direction exceeds the first threshold, and if the communication traffic amounts exceed the second threshold, the CPU 14A sets the detail mode in the second measurement unit 37. The CPU 14A consequently judges that the possibility of micro-bursting occurrence is high. The second measurement unit 37 collects the logs in detail in the detail mode. The CPU 14A recognizes in detail the logs of the communication traffic amounts in the increasing direction in VLAN units based on the logs collected in the detail mode and analyzes causal events occurring, for example, before and after the micro-bursting occurrence.

If the communication traffic amounts do not exceed the second threshold, but if the count value exceeds the third threshold, the CPU 14A sets the detail mode in the second measurement unit 37. Even though the communication traffic amounts do not exceed the second threshold, the CPU 14A consequently judges that the possibility of micro-bursting occurrence is high. The second measurement unit 37 collects the logs in detail in the detail mode. The CPU 14A recognizes in detail the logs of the communication traffic amounts in the increasing direction in VLAN units based on the logs collected in the detail mode and analyzes causal events occurring, for example, before and after the micro-bursting occurrence.

If the communication traffic amounts do not exceed the second threshold, and if the count value does not exceed the third threshold, the CPU 14A sets the normal mode in the second measurement unit 37. The CPU 14A consequently judges that the possibility of micro-bursting occurrence is low. The second measurement unit 37 collects the logs in the normal mode. Since the number of logs collected in the normal mode is reduced, the CPU 14A may save the memory resource of the log storage unit 23.

If the degree of change, in the communication traffic amount, in the increasing direction exceeds the first threshold, the CPU 14A sets the detail mode in the second measurement unit 37. Consequently, if the degree of change in the increasing direction increases drastically, the second measurement unit 37 collects the logs in the detail mode. The CPU 14A analyzes causal events before and after the micro-bursting occurrence based on the collected logs.

If the degree of change, in the communication traffic amount, in the decreasing direction exceeds the first threshold, the CPU 14A sets the detail mode in the second measurement unit 37. Consequently, if the degree of change in the decreasing direction increases drastically, the second measurement unit 37 collects the log in the detail mode. The CPU 14A analyzes causal events of the recovery from micro-bursting based on the collected logs.

For example, the communication traffic amount is measured in VLAN units by the first measurement unit 36. However, the units are not limited to the VLAN, and the communication traffic amount may be measured in flow units. The units may be changed appropriately.

The first measurement unit 36 and the second measurement unit 37 may be run by the NPU 11. The first measurement unit 36 and the second measurement unit 37 may also be run by the CPU 14 (14A), the FPGA 12, or other components. The configuration may be changed appropriately.

The calculation unit 31, the first judgment unit 32 (32A), the second judgment unit 33, the third judgment unit 34, and the controller 35 (35A) may be run by the CPU 14 (14A) or may be run by the FPGA 12, the NPU 11, and other components in a distributed manner.

If the degree of change in the communication traffic amounts exceeds the first threshold during the normal mode, the detail mode may be set in the second measurement unit 37. If the degree of change in the communication traffic amounts does not exceed the first threshold during the detail mode, the normal mode may be set.

The degree of change may be calculated as the degree of change in the communication traffic amounts in accordance with an amount of change in communication traffic amounts corresponding to a predetermined period of time. A graph illustrating temporal changes of a communication traffic amount may be produced in such a manner that the vertical axis and the horizontal axis respectively represent communication traffic amount and time. The inclination angle of the changes may be set as the degree of change.

If the degree of change in the communication traffic amounts exceeds the first threshold, the detail mode is set in the second measurement unit 37. However, instead of the first threshold, a start time and end time of the detail mode may be set by predetermined manipulation. In this case, when the current time reaches the start time, the controller 35 switches and sets the mode from the normal mode to the detail mode. When the current time reaches the end time, the controller 35 switches the mode from the detail mode and sets the normal mode. For example, transmission of daily operation data of branch offices of banks and other organizations to the main office or a data center is scheduled for a predetermined time depending on the branch offices, and a period of time in which a communication traffic amount increases may thus be set for the detail mode. Instead of the first threshold, a time or the like may be set. For example, start and end times for the detail mode may be set using a date or the like.

If the degree of change in the communication traffic amounts exceeds the first threshold, the detail mode may be set in the second measurement unit 37. If the communication traffic amounts exceed the second threshold, the detail mode may be set. If the communication traffic amounts do not exceed the second threshold, the mode may be switched and set to the normal mode.

If the degree of change in the communication traffic amounts does not exceed the first threshold during the detail mode, the mode may be switched and set to the normal mode. If the communication traffic amounts do not exceed the second threshold during the detail mode, the mode may be switched and set to the normal mode.

The first threshold, the second threshold, and the third threshold may be appropriately changed and set in accordance with, for example, predetermined manipulation or a communication load in the network.

The first measurement unit 36 may measure the communication traffic amount in accordance with the 1-ms cycle, and the second measurement unit 37 may measure the communication traffic amount in the detail mode or the normal mode. For example, the first measurement unit 36 may perform a measurement operation of the second measurement unit 37.

In operation S13A or operation S33A, the calculation unit 31 judges whether the acquisition of the communication traffic amounts corresponding to the predetermined period of time (10 ms) is complete. If the acquisition of the communication traffic amounts is complete, the calculation unit 31 calculates the degree of change based on the communication traffic amounts corresponding to the predetermined period of time. For example, after the first measurement unit 36 completes acquisition of communication traffic amounts corresponding to, for example, 100 ms, the calculation unit 31 may divide the 100-ms communication traffic amounts into ten groups of communication traffic amounts and may calculate the degree of change in each 10-ms communication traffic amount resulting from the division into the ten groups of communication traffic amounts. In this case, the first judgment unit 32 serially judges whether the degree of change in each 10-ms communication traffic amount resulting from the division exceeds the first threshold. The third judgment unit 34 may also set the detail mode if the degrees of change in, for example, the seven groups of communication traffic amounts of the degrees of change in the 10-ms communication traffic amounts corresponding to 100 ms (ten groups of communication traffic amounts) each exceed the first threshold, and if, for example, the number of times (count value) the degree of change in the communication traffic amounts exceeds the first threshold exceeds the third threshold of 6.

All or some of the components of the illustrated units may be functionally or physically distributed or integrated on any basis in accordance with a corresponding one of various loads or usages.

All or any of the various processing functions implemented by the devices may be implemented by the central processing unit (CPU) (or a microcomputer such as a micro processing unit (MPU) or a micro controller unit (MCU)). All or any of the processing functions may be run by using a program executed for parsing by the CPU (or the microcomputer such as a MPU or a MCU) or by using hardware based on wired logic.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission device comprising:
one or more processors; and
a memory configured to store a program which is executed by the one or more processors,
wherein the one or more processors is configured to:
measure a communication traffic amount on a line;
calculate a degree of change in the communication traffic amount;
compare the degree of change in the communication traffic amount with a threshold; and
measure, in accordance with a comparison result, the communication traffic amount on the line in accordance with one of a first measurement cycle and a second measurement cycle that is shorter than the first measurement cycle.

2. The transmission device according to claim 1,
wherein when the degree of change exceeds the threshold, the one or more processors measure the communication traffic amount in accordance with the second measurement cycle.

3. The transmission device according to claim 1,
wherein the one or more processors identify a changing direction of the degree of change in the communication traffic amount as an increasing direction or a decreasing direction.

4. The transmission device according to claim 1,
wherein the one or more processors:
measure the communication amount in accordance with the second measurement cycle when a changing direction of the degree of change in the communication traffic amount is identified as an increasing direction and the degree of change in the communication traffic amount exceeds the threshold; and
measure the communication amount in accordance with the second measurement cycle when the changing direction of the degree of change in the communication traffic amount is identified as a decreasing direction and the degree of change in the communication traffic amount exceeds the threshold.

5. The transmission device according to claim 1,
wherein the one or more processors store a log of the communication traffic amount.

6. The transmission device according to claim 1,
wherein the one or more processors calculate, as the degree of change in the communication traffic amount, an amount of change in the communication traffic amount in a period of time.

7. The transmission device according to claim 1,
wherein the one or more processors count a number of times the degree of change in the communication traffic amount exceeds the threshold, and when the counted number of times exceeds a specific number of times, the one or more processors measure the communication traffic amount in accordance with the second measurement cycle.

8. The transmission device according to claim 1,
wherein the one or more processors change the threshold in accordance with a manipulation.

9. A traffic amount measurement method comprising:
measuring, by a computer, a communication traffic amount on a line;
calculating a degree of change in the communication traffic amount;
judging whether the degree of change in the communication traffic amount exceeds a threshold;
determining, based on a judging result, a measurement cycle of the communication traffic amount to one of a first measurement cycle and a second measurement cycle that is shorter than the first measurement cycle; and
measuring the communication traffic amount in accordance with the determined first measurement cycle or the determined second measurement cycle.

10. The traffic amount measurement method according to claim 9,
wherein when the degree of change exceeds the threshold, the communication traffic amount is measured in accordance with the second measurement cycle.

11. The traffic amount measurement method according to claim 9, further comprising:
identifying a changing direction of the degree of change in the communication traffic amount as an increasing direction or a decreasing direction.

12. The traffic amount measurement method according to claim 9, wherein the communication amount is measured in accordance with the second measurement cycle when a changing direction of the degree of change in the communication traffic amount is identified as an increasing direction and the degree of change in the communication traffic amount exceeds the threshold; and the communication amount is measured in accordance with the second measurement cycle when the changing direction of the degree of change in the communication traffic amount is identified as a decreasing direction and the degree of change in the communication traffic amount exceeds the threshold.

13. The traffic amount measurement method according to claim 9,
wherein the one or more processors store a log of the communication traffic amount.

14. The traffic amount measurement method according to claim 9,
wherein an amount of change in the communication traffic amount in a period of time is calculated as the degree of change in the communication traffic amount.

15. The traffic amount measurement method according to claim 9, further comprising:
counting a number of times the degree of change in the communication traffic amount exceeds the threshold: and
measuring, when the counted number of times exceeds a specific number of times, the communication traffic amount in accordance with the second measurement cycle.

16. The traffic amount measurement method according to claim 9, further comprising:
changing the threshold in accordance with a manipulation.
